(19) United States
(12) Patent Application Publication
(10) Pub. No.: US 2009/0202061 A1
(43) Pub. Date: Aug. 13, 2009

(54) METHOD FOR IDENTIFYING SPIT OR SPAM FOR VOIP

(75) Inventors: Joachim Charzinski, München (DE); Christof Störmann, München (DE); Volker Tresp, München (DE); Stefan Hagen Weber, München (DE); Kai Yu, München (DE)

Correspondence Address: K&L Gates LLP, P.O. BOX 1135, CHICAGO, IL, 60690, US

(73) Assignee: NOKIA SIEMENS NETWORKS GMBH & Co. KG, Munchen (DE)

(21) Appl. No.: 12/281,935

(22) PCT Filed: Mar. 2, 2007
(86) PCT No.: PCT/EP2007/051989

§ 371 Date: Sep. 5, 2008

(30) Foreign Application Priority Data
Mar. 6, 2006 (DE) 10 2006 010 153.7

(51) Int. Cl. H04M 3/42

(52) U.S. Cl. 379/210.02

(57) ABSTRACT

The invention relates to a method for the computer-assisted identification of a class of VoIP calls of a first type (spam) in a communication network (internet). Said communication network has a plurality (N) of first subscribers (Tn1-1, . . . , Tn1-5) and a plurality (M) of second subscribers (Tn2-1, . . . , Tn2-7), the first and the second subscribers being allocated a definite characteristic (IP address, telephone number, e-mail address) wherein, at least some of the first subscribers (Tn1-1, . . . , Tn1-5) are allocated, respectively, with at least one list (white list, black list) which contains at least one definite characteristic of the second subscriber. During a call of one of the second subscribers to one of the first subscribers, a control screens to see whether the characteristic of the second subscriber is on the list of the first subscriber and in the event that the second subscriber is not on the list of the called first subscribers, the lists of the additional first subscriber are used to make a decision whether the call is classified as a call of the first type (spam or trusted caller).

### CLAIM FOR PRIORITY

This application is a national stage application of PCT/EP2007/051989, filed Mar. 2, 2007, which claims the benefit of priority to German Application No. 10 2006 010 153.7, filed Mar. 6, 2006, the contents of which hereby incorporated by reference.

### TECHNICAL FIELD OF THE INVENTION

The invention relates to a computer and a method for the computer-assisted identification of a class of calls of the first type in a communication network, and in particular, where the communication network has a number N of first subscribers and a number M of second subscribers and an unambiguous identifier is in each case assigned to the first and the second subscribers.

### BACKGROUND OF THE INVENTION

In conjunction with e-mail, spam has become a great problem which restricts the usability and reliability of e-mail systems and, at the same time, increases the costs for operating and maintaining a communication network for operating e-mails. A similar situation is expected in conjunction with voice over IP (VoIP) when the number of calls made via such a communication network and the number of subscribers have reached a significant level. Such unwanted calls containing e.g. advertising are also called “SPIT” (Spam over IP Telephony).

In contrast to e-mail spam, SPIT causes much more disturbance due to the nature of calls. The annoyance starts when the communication device signals a call. However, the content of the message is only available after the call has been accepted by the called subscriber, that is to say a communication link has been set up. This fact makes it difficult to protect the called subscriber against SPIT.

To protect subscribers of a communication network against SPIT, only information which is exchanged as part of the signaling of a call between the calling subscriber and the called subscriber is thus available. The call can then only be signaled after the end of the check and the finding that there is no SPIT.

### SUMMARY OF THE INVENTION

The present invention discloses a method and a computer such that a class of calls of the first type in a communication network can be reliably identified in order to provide interference-free operation of the communication network.

In one embodiment, there is a method for the computer-assisted identification of a class of calls of the first type in a communication network which has a number N of first subscribers and a number M of second subscribers and an unambiguous identifier is in each case assigned to the first and the second subscribers, includes at least one list which comprises at least one unambiguous identifier of second subscribers is allocated in each case to at least some of the first subscribers. In the case of a call of one of the second subscribers at one of the first subscribers, a check is made whether the identifier of the second subscriber is included in the list of the first subscriber, wherein, in the case in which the second subscriber is not included in the list of the called first subscriber, the lists of the other first subscribers are used for deciding whether the call is classified as a call of the first type.

From a technical point of view, first and second subscribers do not differ but, as has already been explained initially, represent communication devices of the communication network. Functionally considered, the second subscribers are those subscribers which initiate a call. The first subscribers are the subscribers called by the second subscribers.

In the context of the present description, the class of calls of the first type is understood to be spam which, however, is not mandatory. If calls are transmitted in accordance with the Internet Protocol (IP) as is provided in accordance with one embodiment of the invention, the class of calls of the first type is called SPIT (Spam over IP Telephony).

The invention discloses protection of the first subscribers of the communication network against spam or SPIT in that they are allocated personalized lists which contain information about other subscribers and the information contained in the list is used for deciding whether a call contains spam or SPIT.

The list allocated to a first subscriber can in this case comprise identifiers of the second subscribers which initiate calls of the first type or which initiate calls of a second type different from the first type. In technical circles, these lists are also known by the name black list or white list, respectively. A black list is a list of entities—e.g. persons, telephone connections, IP addresses—which are to be disadvantaged in comparison with other entities. The counterpiece of the black list is the white list in which the entities named in the list are preferred compared with the other entities. In the context of the invention, both a black list and a white list or even both lists can be allocated to a first subscriber.

In order to achieve accuracy in identifying calls of the first type, the invention also provides, in the case in which the second subscriber is not included in the list of the called first subscriber, to determine indirectly by checking the lists of other first subscribers whether this could be a call of the first type or not. To determine whether calls of the first type are present, the invention thus uses the evaluation of personalized lists with preferred or otherwise identified subscribers.

If, according to one embodiment, the list represents a black list, no communication set-up between the first and the second subscriber is implemented in the case in which the second subscriber is contained in the list of the called first subscriber. If, according to another variant, the list represents a white list, a communication set-up between the first and the second subscriber is carried out in the case of calls of those second subscribers which are included in the list of one of the first subscribers. In both variants, the caller is classified as a caller of the first type or a caller of the second type in the manner described initially in the cases in which the second subscriber, that is to say the caller, is not included in the list of the called first subscriber.

The determination whether the call is classified as of the first type is carried out by a collaborative filtering method. In this arrangement, the collaborative filtering method can operate in accordance with a memory-based method or in accordance with a model-based method. The collaborative filtering method can also optionally operate in accordance with a method which uses a first subscriber-based approach (so-called user-based approach) or which uses a second subscriber-based approach (so-called item-based approach).

According to one embodiment of the invention, the coincidence of patterns in the lists of the first subscribers is evaluated statistically. A dependence between two of the second subscribers is inferred when these are included in a multiplicity of the lists used for the evaluation. In this context, the invention is based on the approach that similar lists of two first subscribers can be found by a comparison of lists of a plurality of first subscribers. If lists with high correspondence are allocated to two first subscribers, it can be concluded from this that the calls are classified by the first subscribers in accordance with similar principles. Thus, it is possible to infer from the list information of a first subscriber the desired behavior of the other, called first subscriber with a certain probability. It is thus possible to decide whether this is a call of the first or of the second class with a high probability.

In one aspect of the method according to the invention, a value, particularly a probability value, is determined such that it can be decided whether the call is classified as a call of the first type. The probability value is preferably determined by using a Markov chain which is also called Markov Random Walk.

It can also be provided that the value determined or the probability value determined is transformed, wherein is used for a resultant transformation value deciding whether the call is classified as a call of the first type. In this context, the transformation can have been based on a previously specified transformation rule.

In accordance with another embodiment of the method according to the invention, the list can be generated by the relevant first subscriber. The list can be stored locally at the first subscriber but also centrally in a computer of the communication network.

In addition, there are various possibilities how calls which have been classified as calls of the first type can be handled: calls which are classified as calls of the first type can be diverted to a voice announcement or recording device. The calls can be signaled to the first subscriber by means of a particular signaling type, e.g. by means of a particular ringing signal (so-called “distinctive ringing”). The calls can also be signaled to the first subscriber, with the possibility of performing a classification. The latter variant can be used, in particular, if a particular probability value has been exceeded which specifies that there is a call of the first type. This can be implemented by the definition of corresponding intervention instructions in the form of simple rules. In particular, the called first subscriber is then free to block the call, to accept the call (i.e. to set up a connection to the second subscriber), to store the call or to assign to the calling second subscriber a particular signaling type (particularly for future calls).

In another embodiment of the invention, there is a computer for identifying a class of calls of the first type in a communication network can be connected to this communication network. The communication network has a number N of first subscribers and a number M of second subscribers, wherein an unambiguous identifier is in each case assigned to the first and the second subscribers. At least one list which has at least one unambiguous identifier of second subscribers is allocated in each case to at least some of the first subscribers, the computer wherein to check in the case of a call of one of the second subscribers is arranged at one of the first subscribers whether the identifier of the second subscriber is contained in the list of the first subscriber and, in the case in which the second subscriber is not contained in the list of the called first subscriber, to utilize the lists of the further first subscribers for deciding whether the call is classified as a call of the first type.

The computer, in one aspect according to the invention, can be optionally arranged in the first subscriber or an arbitrary computer of the communication network which e.g. is involved in the switching or the setting-up of a communication connection between the calling second subscriber and the called first subscriber.

In still another embodiment of the invention, there is a computer program product which can be loaded directly into the internal memory of a digital computer and comprises software code sections by means of which the steps according to one of the previous claims are executed when the program is running on a computer.

In the present description a subscriber is understood to be a communication device in a communication network communicating, in particular, in accordance with the Internet Protocol (IP). Such a communication device can be, for example, a computer, a telecommunication terminal such as e.g. a landline or mobile telephone, or the like.

In the subsequent description, the term “call” should be understood as the attempt of setting up a communication connection of a second subscriber with a first subscriber.

### BRIEF DESCRIPTION OF THE DRAWINGS

In the text which follows, the invention will be explained in greater detail with reference to the figures, in which:

FIG. 1 shows a representation of the problems forming the basis of the invention.

FIG. 2 shows a first table representing the method of the invention is explained.

FIGS. 3a, b show two probability distributions which can be used for the classification of a call.

FIG. 4 shows a second table representing the procedure according to the invention.

FIG. 5 shows a graph with information included in the second table according to FIG. 4.

### DETAILED DESCRIPTION OF THE INVENTION

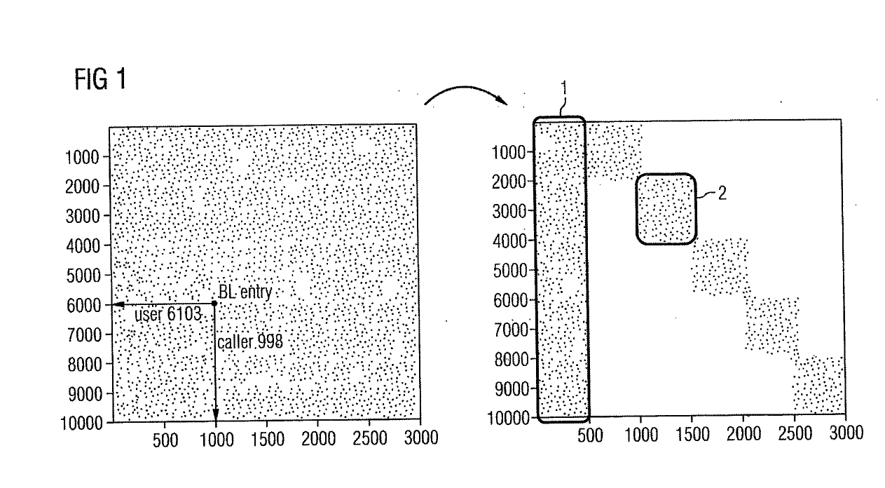

The problem forming the basis of the invention and the selected approach to a solution can be recognized by means of FIG. 1. Two X-Y diagrams are shown wherein in each case the unambiguous identifiers of second subscribers (callers) are represented on the X axis and the unambiguous identifiers of first subscribers (called subscribers) are shown on the Y axis. Each point in the X-Y diagrams represents an entry in the list, e.g. a black list, of a first subscriber. The diagrams comprise for the purpose of illustration N=10000 first subscribers and M=3000 second subscribers. This is shown by way of example for the caller 998 and the called, first subscriber 6103. Due to the entry of an unambiguous identifier of the second subscriber 998 in the black list of the first subscriber 6103, calls of this second subscriber are not switched through at the first subscriber.

While a uniform distribution of entries can be seen in the lists of the first subscribers in the left-hand diagram, the right-hand half of FIG. 1 shows the X-Y diagram after the entries have been regrouped. For the sake of clarity, however, it has been omitted to represent the corresponding unambiguous identifiers in unsorted manner over the X and Y axis. Instead, the representation is again in sorted order.

As can be seen easily, the group of second subscribers, identified by the reference symbol 1, is included in almost all black lists of the first subscribers. In contrast, a group of second subscribers identified by the reference number 2 is also included in the black lists of a group of first subscribers. In addition, several further groups corresponding to block 2 can be seen, the corresponding second subscribers being allocated to a particular group of first subscribers. Tests have shown that such resorting with the representation shown in the right-hand part of the figure is almost always possible.

The analysis of this situation shows that, by using collaborative filtering methods, a classification is possible how the call of a second subscriber can be considered with respect to a first subscriber if the second subscriber is not in the (black) list of the first subscriber. This is made possible by a comparison of the (black) list of the called first subscriber with a multiplicity of (black) lists of further first subscribers which are checked for similarities with the (black) list of the called first subscriber.

To classify whether a call of a second subscriber at a first subscriber in a communication network communicating in accordance with the Internet Protocol is a call of the first type, e.g. SPIT, the invention uses user-defined black and/or white lists. For simpler comprehensibility, black lists will be discussed in the text which follows, the principle also being applicable with white lists or black and white lists as an alternative.

Providing user-defined lists provides for two types of functionality.

1. If a second subscriber which could also be called caller in the text which follows is in the black list of a first subscriber, also called “called subscriber” or “subscriber” in the text which follows, all calls of the caller are blocked at the called subscriber.

This means there is no setting-up of a communication connection between the caller and the called subscriber.

2. The list allocated to a called subscriber also makes it possible to determine the probability whether a call initiated by a caller is SPIT if this caller is not in the list allocated to the called subscriber. In this context, the probability is determined on the basis of the lists of other first subscribers.

The determination of the probability whether a call is SPIT is determined with the aid of collaborative filtering techniques. The basis assumption is that first subscribers which have similar black lists tend to have similar opinions with regard to the decision whether a caller is a spitter or not.

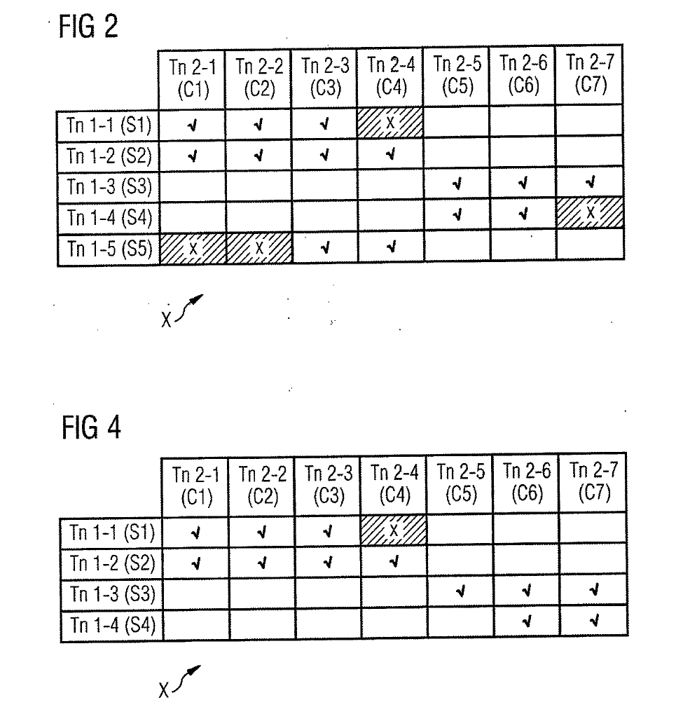

In the text which follows, this is explained in greater detail with reference to FIG. 2. The table shows by way of example M=7 second subscribers Tn2-1, . . . , Tn2-7 which in each case form the column headings of the table. The row headings are represented by, for example, N=5 first subscribers Tn1-1, . . . , Tn1-5. The second subscribers are also called callers, which is why the column designations are supplemented by the reference symbols C1, . . . , C7. Correspondingly, the row headings are supplemented by the reference symbols S1, . . . , S5 since the first subscribers are also called subscribers. A row entry represents, for example, in each case a black list of the first subscribers Tn1-1, . . . , Tn1-5.

A tick in the table row indicates that the associated second subscriber Tn2-1, . . . , Tn2-7 is considered as a so-called spitter. Empty entries in the table mean that, with regard to calls of a relevant second subscriber at a first subscriber, no classification as SPIT has been actively performed by the first subscriber nor has a high SPIT probability been determined as part of the method according to the invention. The shaded table entries identified by X indicate that there is a significant probability that calls of the relevant second subscriber are considered as SPIT for the relevant first subscriber.

According to the procedure of the invention, calls of the second subscriber Tn2-4 for the first subscriber Tn1-1 are classified as SPIT since the first subscribers Tn1-1 and Tn1-2 have similar black lists. From this similarity, it can be concluded that there will also be a similar opinion about the second subscriber Tn2-4.

Correspondingly, callers of the second subscriber Tn2-7 at the first subscriber Tn1-4 are classified as SPIT since the first subscribers Tn1-3 and Tn1-4 have similar black lists. Calls of the second subscriber Tn2-1 at the first subscriber Tn1-5 are considered to be suspicious since the other first subscribers, particularly subscribers Tn1-1 and Tn1-2, have classified the second subscriber Tn2-1 as a spitter. This correspondingly applies to the second subscriber Tn2-2 with regard to the first subscriber Tn1-5. According to the procedure according to the invention, calls of the second subscribers Tn2-1 and Tn2-2 at the first subscriber Tn1-5 are therefore classified as SPIT.

The method according to the invention is thus capable of identifying callers of SPIT if these have been identified as spitters globally, that is to say by a multiplicity of first subscribers, i.e. have been entered in their lists. In addition, the invention makes it possible to identify a second subscriber as a spitter not only globally but, instead, perform an individualized correlation between second and first subscribers as a result of which the different interests of a multiplicity of first subscribers are taken into consideration.

The collaborative filtering has been used for the first time for developing individualized proposal systems. The technology has been successfully used in business-to-customer (B2C)platforms such as e.g. by Amazon. A collaborative filtering algorithm operates with an N-M matrix X in which each row is allocated to a user and each column is allocated to an object (product). Each matrix entry Xᵢⱼ then indicates the opinion of the user i with respect to the product j.

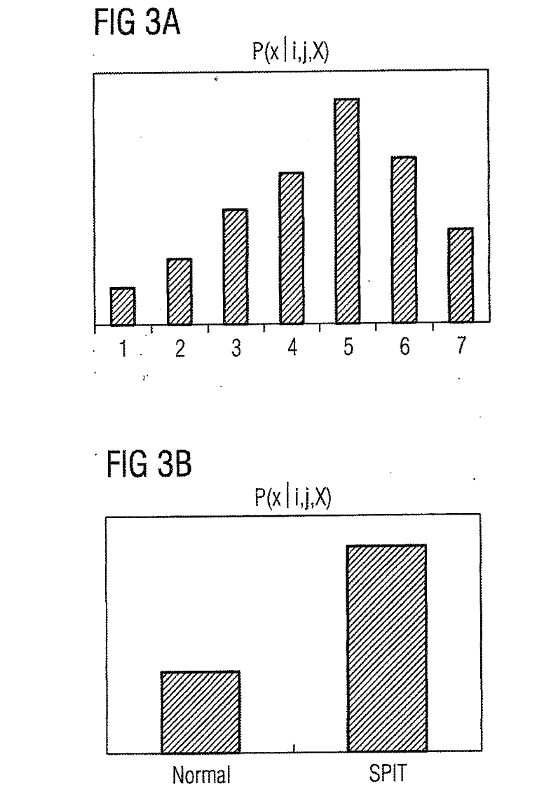

In a corresponding application to the case according to the invention, each user corresponds to a first subscriber and each product to a second subscriber or their respective unambiguous identifiers. Such a matrix X can therefore be very large and provided with few matrix entries since each first subscriber deposits his opinion with respect to an only very small number of second subscribers. This matrix forms the starting point of the collaborative filter in order to predict the opinion of a first subscriber with regard to the missing matrix entries. In particular, a probability is determined in this context. This is expressed by the variable x. The variable x is either a numeric value, e.g. from 1 to 7 as represented in FIG. 3a), or it assumes a binary value, e.g. normal and SPIT (compare FIG. 3b). In the further text, the case mentioned last is considered.

The variable x is dependent on the second subscriber j and the first subscriber i. The aim of the collaborative filtering is therefore the determination of a probability distribution P (x|i,j,X). This is shown in FIGS. 3a) and 3b). In FIG. 3a), an exemplary expected probability distribution for the preferences of the first subscriber is shown in numeric form. The distribution provides not only information about the expected value (5 in the present case) but also about the uncertainty of this estimate. In the example of FIG. 3b), the probability value assumes two values (normal or SPIT), the probability distribution indicating how probable it is that the checked call is SPIT.

In the formalism of P(x|i,j,X), the requirement of i, j and x means that the prediction is different from first subscriber to first subscriber and from second subscriber to second subscriber.

Algorithms of the collaborative filtering can thus be considered as a way of filling all the missing elements of the matrix X. In practice, the filling-up is associated with great memory expenses and a large processing complexity because normal memories cannot contain a complete matrix with millions of elements multiplied by hundreds of thousands of elements. Furthermore, it is not possible to fill up the matrix within a particular time interval. A further problem in practice consists in that not all of the first subscribers will answer enquiries for updating the matrix from a higher-level entity in the communication network. To increase the performance, caching of previously determined probability values may therefore be necessary. In this connection, it is found that, as a rule, making a prediction whether a second subscriber is considered as a spitter or not with respect to a first subscriber does not perform any changes in the list generated by the first subscriber.

The collaborative filtering can be carried out either in a model-based method or a memory-based method as they are called in technical circles. In an early phase, the term of collaborative filtering relates to the memory-based method. This was based on the observation that people usually trust recommendations by acquaintances thinking similarly. These methods apply a nearest-neighbor-like scheme in order to predict the assessment of a user on the basis of the assessments of users thinking similarly. The term “memory-based” originates from the fact that a database with user entries is kept and the contents stored in it are only processed when a prediction is needed. In conjunction with the present invention, this means that, when a first subscriber receives a call, the list of the first subscriber is utilized, in accordance with the memory-based method, to find other first subscribers having similar lists and to check whether the calling second subscriber is also contained in these similar lists.

This is contrasted by the model-based collaborative filtering which learns a compact model which is based on the matrix X considered and then uses the learnt model to make predictions. In this context, there are methods which factorize the matrix X in order to subdivide the very large matrix X into a number of smaller matrices. Each user data record can thus be transformed into latent part-spaces of lesser dimensions. Since these latent part-spaces describe the dependence between first and second subscribers, the part-space describing a user data record can be used for predicting the subscriber interests of the first subscriber with respect to the second subscriber.

Memory-based methods are also called “lazy learning” in the sense that no special training phase is needed. The memory-based method can handle new data by merely adding them to the matrix. In contrast, the model-based method can achieve significant advantages in the computing time so that the prediction can be made very quickly. On the other hand, the incremental adding of models is not trivial.

Both the memory-based and the model-based method of collaborative filter algorithms can be used either in a first subscriber-based approach or a second subscriber-based approach. The first subscriber-based approach is also known as user-based method in technical circles, the second subscriber-based approach is known as item-based method. The following short explanation is given in the context of the memory-based filtering method.

The matrix X is given. This makes it possible to compare the similarity between objects or second subscribers. Two objects or second subscribers are similar if the corresponding columns in the matrix X are similar. This means that each user tends to have a similar opinion of the two objects or second subscribers.

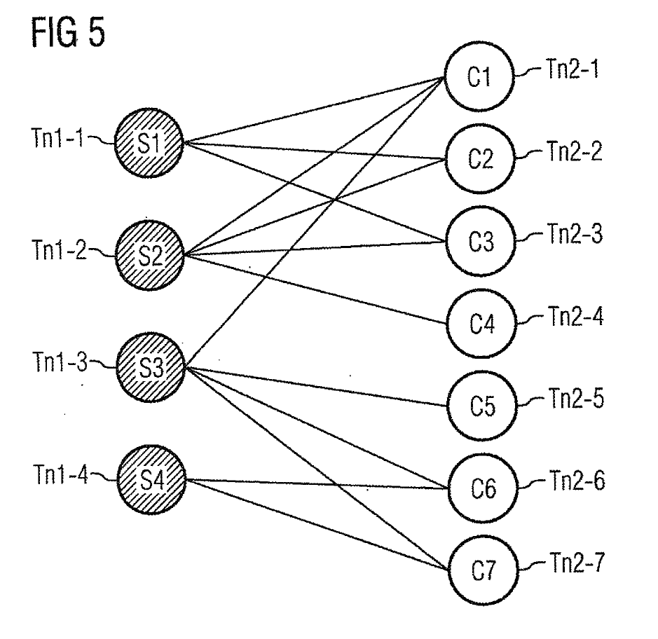

This procedure is explained further by means of the example of FIG. 4. Assuming that the second subscriber Tn2-4 is similar to the second subscribers Tn2-1, Tn2-2 and Tn2-3, this assumption being based on the list entries of the other first subscribers, it is probable that a first subscriber has a similar opinion with respect to these four second subscribers. If a first subscriber has entered the second subscribers Tn2-1, Tn2-2 and Tn2-3 into his black list, the second subscriber Tn2-4 is with high probability a spitter for this certain first subscriber.

In a situation in which the number of first subscribers is dynamic and much greater than the number of second subscribers, the item-based method is preferred for mathematical reasons.

In the context of the invention, it is thus attempted to model the statistical coincidence of second subscribers in the lists of the first subscribers. The dependence between two second subscribers is reflected by the circumstance that these often occur simultaneously in the same black lists of the first subscribers. This procedure is equivalent to the user-based approach although it appears to be an item-based approach. For modeling the coincidence of second subscribers, the Markov chain familiar to the expert, which is also known as Markov Random Walk, is used. For this purpose, a non-directional graph G (V, E, W) is considered, where V represents a set of nodes, E represents a set of edges which join the nodes V to one another and W represents an adjacent matrix which assigns to each edge [i,j] an edge weight Wᵢⱼ≧0. The indices [i,j] designate the edge which joins a node Vᵢ and a node Vⱼ to one another. The transition probability of the Markov chain from Vᵢ to Vⱼ is defined as:

Pᵢⱼ=Wᵢⱼ/Dᵢ, in which Dᵢ=ΣⱼWᵢⱼ.

The edge weight Wᵢⱼ can be interpreted as the frequency of transitions between Vᵢ and Vⱼ. Pᵢⱼ can thus be considered as how large the proportion of all transitions relating to the node Vᵢ is in relation to the transition from Vᵢ to Vⱼ.

A transition thus codes a coincidence pattern of two nodes linked to one another. An edge weight Wᵢⱼ having a high value indicates a frequent coincidence of the two nodes. Pᵢⱼ thus codes the conditional probability, when Vᵢ occurs, how probable it is that Vᵢ also occurs. This conditional probability is used for inferring the SPIT probability of a new second subscriber with respect to the lists of all first subscribers.

The database of the black lists of the first subscribers directly describes the coincidence of pairs of first subscribers and second subscribers. FIG. 5 shows the example of a non-directional graph which takes into consideration the information of the matrix contained in FIG. 4. In this context, the first subscribers Tn1-1 to Tn1-4 are denoted by the nodes S1 to S4 and the second subscribers Tn2-1 to Tn2-7 are denoted by the nodes C1 to C7.

On the basis of this graph, a collaborative filtering can be carried out in accordance with the user-based approach. In the following example, it is assumed that the SPIT probability for the first subscriber (designated as S1 in the figure) can be predicted with the following steps.

1. Initialization (t=0). Since the prediction is concentrated on the first subscriber Tn1-1, the entire probability mass is placed on the node S1. This means Pₜ₌₀ (S1)=1.

2. First jump t=1: in this step, the process jumps from node S1 to nodes C1, C2 and C3 which are connected to node S1 via edges. The probability of a transition is in each case one third: Pₜ₌₁(C1)=⅓, Pₜ₌₁(C2)=⅓ and Pt=₁(C3)=⅓.

3. Second jump t=2: when the chain is continued (Random Walk) the nodes S1, S2 and S3 connected to the nodes C1, C2 and C3 again receive a probability mass. This results in Pₜ₌₂(S2)=⅓·⅓+⅓·½+⅓·½= 4/9, Pₜ₌₂(S3)=⅓·⅓= 1/9, Pₜ₌₂(S4)=0. This results from the fact that node S4 is not connected to any of nodes C1, C2 and C3 via an edge.

4. Third jump t=3: following a further transition results in: Pₜ₌₃(C4)= 4/9·¼= 1/9, Pₜ₌₃(C5)=Pₜ₌₃(C6)=Pₜ₌₃(C7)= 1/36.

The result is that for node S1 (the first subscriber) Tn1-1, the SPIT probability of node C4 (subscriber Tn2-4) is much higher than that of the other second subscribers who are not on the black list of the first subscriber Tn1-1.

The method of the Markov chain as illustrated above can be considered as a user-based approach since the user similarity is measured by the transitions between users. The similarity between first subscribers is caused by the two-step transition on the graph in FIG. 5, namely from the first subscribers to the second subscribers back to the first subscribers.

The Markov method can be considered equivalently as an object-based approach in which the similarity of the object or the second subscriber, respectively, is measured by the transitions between the products or second subscribers, respectively. This similarity is caused by a two-step transition on the graph of FIG. 5 which extends from the second subscribers to the first subscribers and finally back to the second subscribers.

In the example described above, the object-based approach can be considered as a Markov chain (Random Walk), beginning from t=1 in which the probability masses are: Pₜ₌₁(C1)=⅓, Pₜ₌₁(C2)=⅓ and Pₜ₌₁(C3)=⅓. Since the black list is given for node S1, the following can be set as initial state: Pₜ₌₁(C1)=1, Pₜ₌₁(C2)=1 and Pₜ₌₁(C3)=1. The SPIT probability for the other second subscribers is: Pₜ₌₃(C4)=⅓, Pₜ₌₃(C5)=Pₜ₌₃(C6)=Pₜ₌₃(C7)= 1/12. The difference is thus only the factor 3.

In a situation in which the number of first subscribers is much greater than that of the calling second subscribers, the object-based approach is more efficient. The procedure is in this case identical to that described previously.

The invention thus proposes a method for computer-assisted identification of calls of a particular class (particularly spam or SPIT, respectively) in IP telephony. In this context, it is possible, in particular, to avoid such calls in an individualized manner, that is to say for each called first subscriber. For this purpose, the invention makes use of lists defined by the subscribers which can be arranged as black lists or white lists in order to be able to draw conclusions regarding the probable behavior of the first subscriber. The invention uses collaborative filtering methods which are applied to the lists defined by the subscribers.

1. A method for the computer-assisted identification of a class of calls of a first type in a communication network, the communication network having a number N of first subscribers and a number M of second subscribers and an unambiguous identifier in each case assigned to the first and the second subscribers, comprising:
allocating at least one list which comprises at least one unambiguous identifier of the second subscribers in each case to at least some of the first subscribers; and
when a call of one of the second subscribers at one of the first subscribers, checking whether the unambiguous identifier of the second subscriber is included the list of the first subscribers, wherein, when the second subscriber is not included in the list of the called first subscribers, the lists of the other first subscribers are used for deciding whether the call is classified as a call of the first type.

2. The method as claimed in claim 1, wherein the list allocated to one of the first subscribers comprises the unambiguous identifiers of the second subscribers which initiate calls of the first type.

3. The method as claimed in claim 2, wherein when the second subscriber is included in the list of the called first subscriber, no communication set-up occurs between the first and the second subscriber.

4. The method as claimed in claim 1, wherein
the list allocated to a first subscriber comprises the unambiguous identifiers of the second subscribers which initiate calls of a second type.

5. The method as claimed in claim 4, wherein when calls of the second subscribers which are included in the list of one of the first subscribers, a communication is set up between the first and the second subscriber.

6. The method as claimed in claim 1, wherein the determination whether the call is classified as a call of the first type is made by a collaborative filtering method.

7. The method as claimed in claim 6, wherein the collaborative filtering method operates in accordance with a memory-based method.

8. The method as claimed in claim 6, wherein the collaborative filtering method operates in accordance with a model-based method.

9. The method as claimed in claim 6, wherein the collaborative filtering method operates in accordance with a method which uses a first subscriber-based approach (user-based approach).

10. The method as claimed in claim 6, wherein the collaborative filtering method operates in accordance with a method which uses a second subscriber-based approach (item-based approach).

11. The method as claimed in claim 1, wherein the coincidence of patterns in the lists of the first subscribers is evaluated statistically.

12. The method as claimed in claim 1, wherein a dependence between two of the second subscribers is inferred when included in a multiplicity of the lists used for the evaluation.

13. The method as claimed in claim 1, wherein a probability value is determined to decide whether the call is classified as the first type.

14. The method as claimed in claim 13, wherein the probability value is determined by using a Markov chain (Markov Random Walk).

15. The method as claimed in claim 13, wherein the probability value determined is transformed, wherein a resultant transformation value is used for deciding whether the call is classified as a call of the first type.

16. The method as claimed in claim 1, wherein the list is generated by the relevant first subscriber.

17. The method as claimed in claim 1, wherein
calls which are classified as calls of the first type are diverted to a voice announcement or recording device.

18. The method as claimed in claim 1, wherein calls which are classified as calls of the first type are signaled to the first subscriber by a particular signaling type.

19. The method as claimed in claim 1, wherein calls which are classified as calls of the first type are signaled to the first subscriber to perform a classification.

20. The method as claimed in claim 1, wherein the communication between two subscribers of the communication network is carried out in accordance with the Internet Protocol (IP).

21. A computer program product which can be loaded directly into the internal memory of a digital computer and comprises software code sections executable when the program is running on a computer, comprising:
identifying a class of calls of a first type in a communication network, the communication network having a number N of first subscribers and a number M of second subscribers and an unambiguous identifier in each case assigned to the first and the second subscribers;
allocating at least one list which comprises at least one unambiguous identifier of the second subscribers in each case to at least some of the first subscribers; and
when a call of one of the second subscribers at one of the first subscribers, checking whether the unambiguous identifier of the second subscriber is included in the list of the first subscribers, wherein, when the second subscriber is not included in the list of the called first subscribers, the lists of the other first subscribers are used for deciding whether the call is classified as a call of the first type.

22. A computer for identifying a class of calls of a first type in a communication network, which can be connected to the communication network, the communication network having a number N of first subscribers and a number M of second subscribers, wherein an unambiguous identifier is in each case assigned to the first and the second subscribers, comprising:
allocating at least one list which has at least one unambiguous identifier of second subscribers in each case to at least some of the first subscribers, wherein the computer is arranged to check, when a call of one of the second subscribers at one of the first subscribers,
whether the identifier of the second subscriber is included in the list of the first subscriber and, when the second subscriber is not included in the list of the called first subscriber, to utilize the lists of the further first subscribers for deciding whether the call is classified as a call of the first type.

23. (canceled)
